(19) United States
(12) Patent Application Publication
(10) Pub. No.: US 2011/0138463 A1
(43) Pub. Date: Jun. 9, 2011

(54) METHOD AND SYSTEM FOR DDOS TRAFFIC DETECTION AND TRAFFIC MITIGATION USING FLOW STATISTICS

(75) Inventors: Hak Suh KIM, Daejeon (KR); Kyoung-Soon KANG, Daejeon (KR); Ki Cheol JEON, Daejeon (KR); Bong Tae KIM, Daejeon (KR); Byungjun AHN, Daejeon (KR)

(73) Assignee: Electronics and Telecommunications Research Institute, Daejeon (KR)

(21) Appl. No.: 12/946,849

(22) Filed: Nov. 15, 2010

(30) Foreign Application Priority Data
Dec. 7, 2009 (KR) 10-2009-0120542
Jun. 11, 2010 (KR) 10-2010-0055496

(51) Int. Cl. G06F 11/00

(52) U.S. Cl. 726/22

(57) ABSTRACT

Disclosed are a method and system for distributed denial of service (DDoS) attack detection and traffic mitigation using flow statistics. The method for DDoS attack detection and traffic mitigation using flow statistics includes: collecting first statistics for each flow based on flow information generated by traffic flow of a network connection device; and grouping the first statistics for each flow on a per-flow basis and processing the same into second statistics containing at least one of the number of bytes, the number of packets, and the number of flows per unit time.

### CROSS-REFERENCE TO RELATED APPLICATION

This application claims priority to and the benefit of Korean Patent Application Nos. 10-2009-0120542 and 10-2010-0055496 filed in the Korean Intellectual Property Office on Dec. 7, 2009 and Jun. 11, 2010, the entire contents of which are incorporated herein by reference.

### BACKGROUND OF THE INVENTION

(a) Field of the Invention

The present invention relates to a method and system for distributed denial of service (DDoS) attack detection and traffic mitigation using flow statistics.

(b) Description of the Related Art

In general, a distributed denial of service (DDoS) attack means that a malicious attacker instantaneously sends a large amount of data to a target system, such as a web service server on the Internet and a network to which the system belongs, to disturb the normal operations of the corresponding system and network.

FIG. 1 is a network configuration view showing an example of a typical distributed denial of service (DDoS) attack.

An attack terminal 100 is infected with a malicious virus, like a zombie computer, and generates a large amount of traffic to an attack target server 500. In general, a router 200 sends all incoming traffic to a network having a DDoS defense system 300, an IPS defense system 400, an attack target server 500, etc. At this point, various types of equipment that sit behind the router 200 cannot perform their functions properly and are brought down due to too much incoming aggressive traffic, or cannot service normal user traffic due to heavy load. Moreover, as the traffic across the entire network increases due to a large amount of aggressive traffic, efficient use of expensive resources is not possible.

Traffic types for this attack include TCP SYN flooding, ICMP flooding, UDP flooding, and so on.

A TCP SYN flooding attack is an attack that causes a server to establish a lot of TCP connections by continuously sending only SYN packets to the server, and therefore exhausts the resources of the server. An attack of this type is seemingly normal traffic flow, so it is very hard to detect such an attack. With the existing detection methods, DDoS attacks cannot be detected perfectly, and an attack is recognized and handled after a long time since the occurrence of the attack, thus failing to provide a normal service for a considerable length of time.

Conventional attack detection methods include a method of detection at a source/attacker side, a method of detection at a destination/victim side, and a method of detection in a core network. Representative techniques thereof include a pushback technique and an IP traceback technique.

Among them, the pushback technique is used to detect attacks by observing packet drop statistics in individual routers on a network. Since a DDoS attack generated by an attacker, such as a zombie computer, reaches its destination via various paths, a large number of packets are dropped at a router near the destination where the number of attack packets is increasing. That is, in this case, the router near the destination transmits a pushback message via a path through which the packets were sent, and another router having received this message interrupts the forwarding of the corresponding traffic and continues to transmit a pushback message toward the path from which the packets are coming, thereby entirely blocking attack packets.

However, the existing pushback technique has a problem in properly dealing with the current trend of DDoS attacks coming from zombie computers. Because attack computers are distributed over a network, much time and resources are consumed in the delivery of a pushback message to all individual routers. Accordingly, the delivery of a pushback message rather imposes an additional load on the network.

The IP traceback technique provides the function of notifying an attack target system manager of an actual attack source IP address of a DDoS attack. The IP traceback technique is categorized into a technique using marking methodology focusing on packets, a technique for managing information of a source packet forwarding path through deformation of a protocol, such as ICMP (Internet control message protocol), and a technique utilizing a management protocol in terms of network structure. The IP traceback technique is categorized into proactive traceback technology and reactive traceback technology according to the types of responses to attacks.

However, the IP traceback technique has many problems in determining the source IP address under the current situation of multistage attacks. Moreover, a large number of memory chips have to be provided inside a router, and the router has to process a large amount of information, thus causing an adverse effect on the performance of the router. Further, a lot of time is required to actually block traffic.

As noted above, the existing DDoS detection methods have the problem that much time and resources are consumed to detect the presence of a DDoS attack, and an attack target server cannot be protected from an enormous amount of attack traffic. Therefore, there is an urgent need for a solution to quickly detect and handle a DDoS attack or abnormal traffic.

The above information disclosed in this Background section is only for enhancement of understanding of the background of the invention and therefore it may contain information that does not form the prior art that is already known in this country to a person of ordinary skill in the art.

### SUMMARY OF THE INVENTION

Accordingly, the present invention has been made in an effort to solve the above-mentioned problems and to provide a method and system for quick distributed denial of service (DDoS) attack detection and traffic mitigation using flow statistics.

An exemplary embodiment of the present invention provides a method for distributed denial of service (DDoS) attack detection and traffic mitigation using flow statistics, the method including:

collecting first statistics for each flow based on flow information generated by traffic flow of a network connection device; grouping and classifying the first statistics for each flow on a per-flow basis and processing the same into second statistics containing at least one of the number of bytes, the number of packets, and the number of flows per unit time; calculating the rate of change of the second statistics, and if the rate of change exceeds a preset threshold rate, determining that a distributed denial of service attack is occurring; and limiting the flow rate of the traffic based on a predefined policy by executing a rate-limit function according to a result of the determination.

The limiting further includes reporting a DDoS attack event to a policy management server that manages network policies according to a result of the determination.

An exemplary embodiment of the present invention provides a system for distributed denial of service (DDoS) attack detection and traffic mitigation using flow statistics, the system including,

a flow statistics collector that collects first statistics for each flow based on flow information generated by traffic flow of a network connection device; a statistics processor that groups and classifies the first statistics for each flow on a per-flow basis and processes the same into second statistics containing at least one of the number of bytes, the number of packets, and the number of flows per unit time; a determiner that calculates the rate of change of the second statistics, and if the rate of change exceeds a preset threshold rate, determines that a distributed denial of service attack is occurring; and a controller that limits the flow rate of the traffic based on a predefined policy by executing a rate-limit function according to a result of the determination.

The system further includes: a packet forwarding processor that looks up packets received from the interface of a line card of a router system in a routing table to forward the packets to a corresponding destination node, and generates flow information to be classified by a plurality of tuples; and a database storing the routing table and a statistics table having the second statistics.

### BRIEF DESCRIPTION OF THE DRAWINGS

FIG. 1 is a network configuration view showing an example of a typical distributed denial of service (DDoS) attack.

FIG. 2 is a block diagram schematically showing a router having the system for DDoS detection and traffic mitigation using flow statistics according to the exemplary embodiment of the present invention.

FIG. 3 is a flowchart showing a method for DDoS detection and traffic mitigation using flow statistics according to the exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

Now, a method and system for distributed denial of service (DDoS) attack detection and traffic mitigation using flow statistics according to an exemplary embodiment of the present invention will be described in detail with reference to the accompanying drawings.

In the present invention, a flow-based router performs quick detection of a DDoS attack based on the rate of change of statistics per unit time using flow statistics. Also, in order to prevent the exhaustion of network resources upon detection of a DDoS attack, the DDoS attack is reported to a network policy server (not shown) to reduce incoming traffic, and in order to ensure prompt action, a rate-limit function is defined for the incoming traffic to reduce the traffic volume.

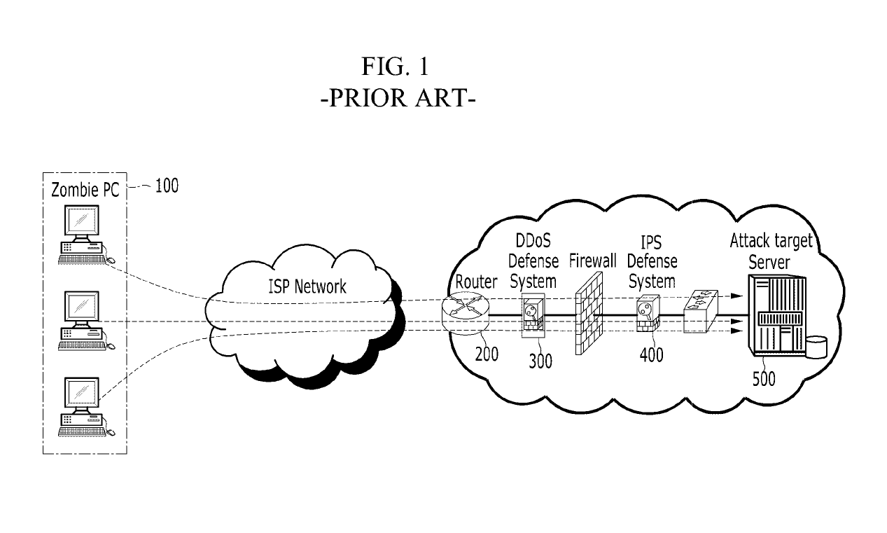

Referring to the network configuration showing an example of distributed denial of service (DDoS) of FIG. 1, attack terminals 100 are zombie computers infected with a malicious virus, which are source nodes to be connected via a wired or wireless Internet connection. An attack target server 500 is a server of a service provider that provides a variety of services in response to a connection from the source nodes.

Herein, the system for distributed denial of service (DDoS) attack detection and traffic mitigation using flow statistics according to the exemplary embodiment of the present invention can be applied to a router 200.

That is, the router 200 of FIG. 1 is equipped with the system for DDoS attack detection and traffic mitigation according to the exemplary embodiment of the present invention, and quickly detects attack traffic in the event of a DDoS attack and reports this to the network policy server. Moreover, various types of equipment (e.g., 300, 400, and 500) in the network can be protected by defining the rate-limit function for the detected traffic to reduce the traffic volume.

The following description will be made with respect to the case where the system for DDoS detection and traffic mitigation is equipped in the router 200 for convenience of explanation. However, the present invention is not limited to the case where the system for DDoS detection and traffic mitigation is equipped in the router 200, but the system may be configured as an independent device and may work in conjunction with other network devices capable of traffic management, as well as with the router, or may be applied to their systems.

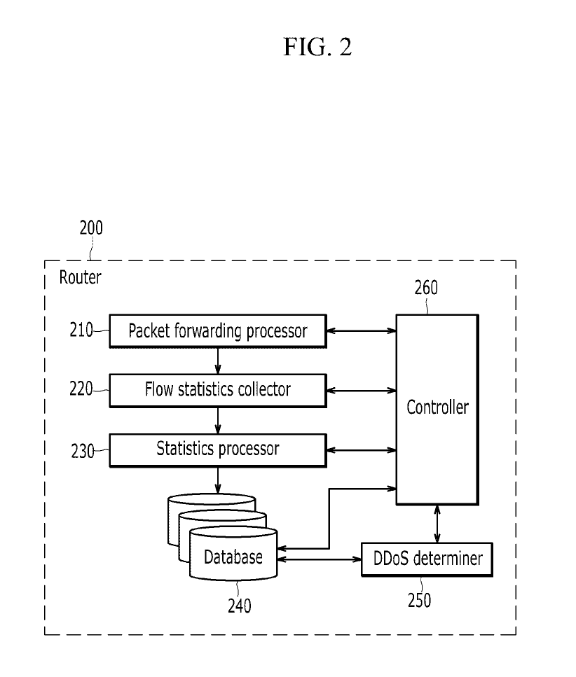

FIG. 2 is a block diagram schematically showing a router having the system for DDoS detection and traffic mitigation using flow statistics according to the exemplary embodiment of the present invention.

Referring to the accompanying FIG. 2, the router 200 according to the exemplary embodiment of the present invention includes a packet forwarding processor 210, a flow statistics collector 220, a statistics processor 230, a database 240, a DDoS determiner 250, and a controller 260.

The packet forwarding processor 210 executes the function of looking up packets received from the interface of a line card of the router system in a routing table stored in the database 240, and forwarding the packets to a corresponding destination. Moreover, the packet forwarding processor 210 processes (generates) packets on a per-flow basis to be classified by five tuples. Also, the packet forwarding processor 210 serves to forward a first packet, an intermediate n-th packet, and a flow ending packet for each flow to the flow statistics collector 220.

Here, the flow is defined as a set of packets having the same information based on five tuples of source address, destination address, source port, destination port, and protocol ID, which are the header information of IP packets.

The packet forwarding processor 210 may define the flow to be a set of packets, whose five tuples are all the same, or a set of packets, of which only part of the five tuples is the same according to the purpose of use. For example, a flow can be defined as a set of packets that have the same source address, destination address, source port, destination port, and protocol ID, or a flow can be defined as a set of packets that have the same source address and destination address. Moreover, a flow can be defined by adding more entries or using only part of the five tuples according to the purpose of use.

The flow statistics collector 220 receives each packet from the packet forwarding processor 210, and collects flow statistics, including the number of bytes processed so far, number of packets, number of blocked packets, etc. (hereinafter referred to as “first statistics”).

The statistics processor 230 classifies the first statistics for each flow collected by the flow statistics collector 220 into groups by source address, destination address, source-destination address, and protocol ID, and processes them into statistics (hereinafter referred to as “second statistics”) containing the number of bytes, the number of packets, and the number of flows per unit time. Also, the statistics processor 230 stores the processed second statistics in a statistics table of the database 240.

The database 240 has various data and programs for distributed denial of service (DDoS) attack detection and traffic mitigation using flow statistics, and stores data generated according to the operations thereof.

The DDoS determiner 250 calculates the rate of change of the second statistics per unit time stored in the statistics table at predetermined intervals, and if the rate of change exceeds a preset threshold rate, determines that a DDoS attack is occurring and informs the controller 260 of the DDoS attack. That is, the DDoS determiner 250 reads the second statistics in the statistics table for DDoS detection every predetermined time and periodically calculates the rate of change of the second statistics between the last (previous) interval and the current interval, and determines that a DDoS attack is occurring if the rate of change is greater than a predetermined level based on the rate of change of the second statistics.

At this point, the DDoS determiner 250 can define the threshold rate for each of a plurality of stages, and can determine that abnormal traffic, a suspected DDoS attack, or a DDoS attack is occurring depending on a degree to which the rate of change of the second statistics exceeds a preset threshold rate for each stage.

Moreover, the DDoS determiner 250 may check the number of passed packets per unit time (e.g., pps (packet per second)), and, if the number of packets is above an appropriate level for one source node (PC) or the like, considers it as a DDoS attack. Here, the appropriate level may be a threshold of the number of packets permitted for one source node per unit time according to policies, and may be checked based on the number of packets per unit time of a source address or source port.

Further, the DDoS determiner 250 may process information by source address, destination address, source-destination address, and protocol ID, and therefore determines whether a DDoS attack is occurring in various combinations according to the location of the router 200 on the network.

For example, in FIG. 1, the router 200 can easily identify a zombie computer in a DDoS attack if flow statistics are processed for each source address. Additionally, if flow statistics for each destination address are processed for identification, a server under the DDoS attack can be identified.

The controller 260 serves to control the operation of each part in the router for distributed service of denial (DDoS) attack detection and traffic mitigation using flow statistics.

Upon receipt of a DDoS attack event in accordance with the determination of the DDoS determiner 250, the controller 260 sends suspected traffic information to a network policy management server responsible for network policies to notify the network policy management server of abnormal traffic in the network, thereby enabling more accurate detection of DDoS attack patterns.

Particularly, in the case that there is no network policy management server, or even if there is, if it is necessary for the controller to take prompt action against DDoS attacks and abnormal traffic, the controller 260 can limit the flow rate of traffic and report it by controlling such that the rate-limit function for traffic mitigation is executed on the corresponding traffic in the router 200. Here, the limiting includes mitigating a large amount of traffic and blocking traffic of a source node suspected of being a zombie computer.

As such, the router 200 according to the exemplary embodiment of the present invention is capable of detecting abnormal traffic very quickly by periodically checking and processing real-time information collected in the router 200 and detecting whether there is DDoS traffic. Also, the router 200 can actively handle DDoS attacks by promptly reporting event information on detected abnormal traffic to the network policy management server, or, to ensure more prompt action, by executing the rate-limit function on the abnormal traffic detected by the router 200 and limiting the traffic.

The system for DDoS detection and traffic mitigation according to the exemplary embodiment of the present invention is applicable to all the routers 200 on a network including a core network, and, each individual router 200 can quickly block attack traffic and promptly report it, thereby making efficient use of resources across the network.

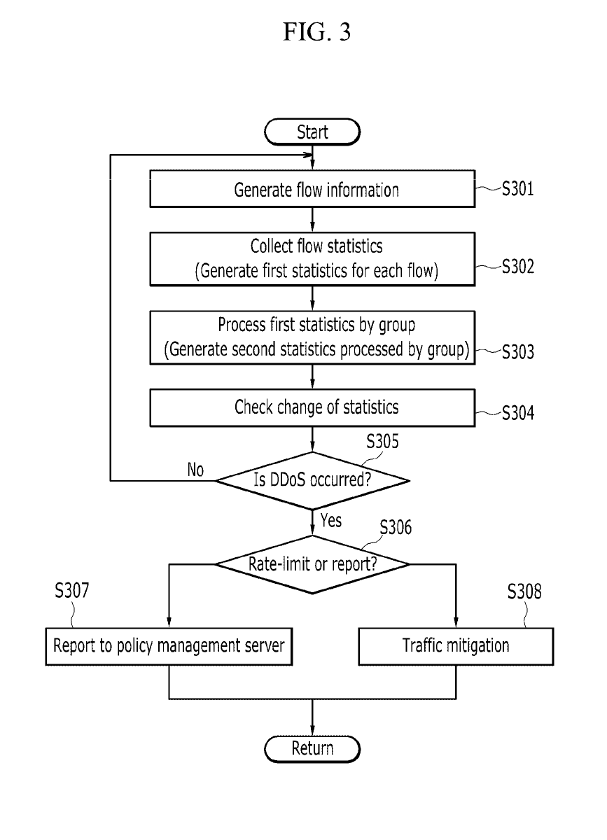

Now, a method for DDoS detection and traffic mitigation using flow statistics by the router 200 according to the exemplary embodiment of the present invention described so far will be described with reference to FIG. 3.

FIG. 3 is a flowchart showing a method for DDoS detection and traffic mitigation using flow statistics according to the exemplary embodiment of the present invention.

Referring to the accompanying FIG. 3, a packet forwarding processor 210 of a router 200 equipped with the system according to the exemplary embodiment of the present invention monitors traffic passing through the router 200, and processes packets to be classified by five tuples on a per-flow basis and generates flow information (S301).

The router 200 collects first statistics for each flow, including the number of flows, the number of bytes, the number of packets, etc. based on the generated flow information (S302). Also, the router 200 classifies the collected first statistics for each flow into groups by source address, destination address, source-destination address, and protocol ID, and processes them into second statistics containing the number of bytes, number of packets, and number of flows per unit time (S303).

The router 200 checks the rate of change on the second statistics per unit time stored in a statistics table at predetermined intervals (S304), and if the rate of change exceeds a preset threshold rate, determines that a DDoS attack is occurring (S305).

The router 200 reports a DDoS attack to a policy management server in accordance with a predefined policy, or determines whether to execute the rate-limit function (S306). According to a result of the determination, the router 200 reports a DDoS attack event to the policy management server that manages network policies (S307), or executes the rate-limit function to mitigate traffic by itself (S308). At this point, in some cases, the router 200 may execute the rate-limit function to mitigate traffic by itself, simultaneously with reporting to the policy management server.

As such, according to the exemplary embodiment of the present invention, individual routers on a network can detect suspected DDoS traffic in real time using flow statistics and quickly report it to the policy management server managing the network, thus allowing the policy management server to take prompt action against the DDoS.

In addition, it can be expected that, even if there is no policy server, various equipment in the network can be made serviceable by reducing or blocking a large amount of incoming traffic by the system itself.

Conventionally, there is a problem in that web servers and service servers cannot operate normally due to very slow action against DDoS, and this may cause huge losses and tarnish the companies' images. However, according to the exemplary embodiment of the present invention, it is possible to easily recognize a large amount of attack traffic starting from an end of the router 200, and take prompt action against it, thereby enabling the attack target server to provide services without interruption.

Moreover, while the conventional pushback technique causes a load to transmit a pushback message to the previous router, the exemplary embodiment of the present invention has the advantage of not generating a load, such as pushback message transmission, since each individual router 200 determines whether there are DDoS and abnormal traffic.

Further, while the conventional IP traceback technique requires a large number of memory cards and processing capability, the exemplary embodiment of the present invention has the advantage that it requires less memory cards than the IP traceback technique, and, accordingly, lower processing capability since only flow statistics are managed in groups.

In addition, while the key solution to DDoS attacks is to quickly detect an attack and take action against it, the conventional art has the problem that it takes a lot of time for DDoS detection equipment to detect whether a DDoS attack is occurring, and a web server, a service server, etc. cannot perform their functions due to an enormous amount of attack traffic.

To overcome these problems, according to the exemplary embodiment of the present invention, individual routers on a network quickly detect DDoS attacks and instantly report a DDoS event or mitigate traffic according to a result of the detection.

That is, according to the exemplary embodiment of the present invention, individual routers on a network can detect suspected DDoS traffic in real time using flow statistics and quickly report it to the policy management server managing the network, thus allowing the policy management server to take prompt action against the DDoS.

In addition, it can be expected that, even if there is no policy server, various equipment in the network can be made serviceable by reducing or blocking a large amount of incoming traffic by the system itself.

The above-described exemplary embodiment can be realized through a program for realizing functions corresponding to the configuration of the exemplary embodiment of the present invention or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for distributed denial of service (DDoS) attack detection and traffic mitigation using flow statistics, the method comprising:
collecting first statistics for each flow based on flow information generated by traffic flow of a network connection device;
grouping and classifying the first statistics for each flow on a per-flow basis and processing the same into second statistics containing at least one of a number of bytes, the number of packets, and the number of flows per unit time;
calculating the rate of change of the second statistics, and if the rate of change exceeds a preset threshold rate, determining that a distributed denial of service attack occurs; and
limiting the flow rate of the traffic based on a predefined policy by executing a rate-limit function according to a result of the determination.

2. The method of claim 1, wherein the limiting of the flow rate further comprises reporting a DDoS attack event to a policy management server that manages network policies according to a result of the determination.

3. The method of claim 1, wherein the first statistics for each flow contain at least one of the number of flows, the number of bytes, and the number of packets that are periodically processed.

4. The method of claim 1, wherein the grouping of the first statistics comprises grouping the first statistics for each flow by at least one of source address, destination address, source-destination address, and protocol ID.

5. The method of claim 1, wherein the determining comprises checking the number of passed packets per unit time, and if the number of packets exceeds a threshold level for one source node, determining that a DDoS attack is occurring.

6. The method of claim 1, wherein the limiting of the flow rate comprises mitigating the flow rate of the traffic or blocking traffic of a source node suspected of the DDoS attack.

7. A system for distributed denial of service (DDoS) attack detection and traffic mitigation using flow statistics, the system comprising:
a flow statistics collector that collects first statistics for each flow based on flow information generated by traffic flow of a network connection device;
a statistics processor that groups and classifies the first statistics for each flow on a per-flow basis and processes the same into second statistics containing at least one of the number of bytes, the number of packets, and the number of flows per unit time;
a determiner that calculates the rate of change of the second statistics, and if the rate of change exceeds a preset threshold rate, determines that a distributed denial of service attack is occurring; and
a controller that limits the flow rate of the traffic based on a predefined policy by executing a rate-limit function according to a result of the determination.

8. The system of claim 7, further comprising:
a packet forwarding processor that looks up packets received from the interface of a line card of a router system in a routing table to forward the packets to a corresponding destination node, and generates flow information to be classified by a plurality of tuples; and
a database storing the routing table and a statistics table having the second statistics.

9. The system of claim 7, wherein the controller reports a DDoS attack event to a policy management server that manages network policies according to a result of the determination, and mitigates the flow rate of the traffic or blocks traffic of a source node suspected of the DDoS attack.

10. The system of claim 7, wherein the determiner defines the threshold rate for each of a plurality of stages, and determines that one of abnormal traffic, a suspected DDoS attack, and a DDoS attack is occurring depending on a degree to which the rate of change of the second statistics exceeds a preset threshold rate for each stage.
